(19) United States
(12) Patent Application Publication
(10) Pub. No.: US 2003/0135672 A1
(43) Pub. Date: Jul. 17, 2003

(54) System having tape drive emulator and data cartridge carrying a non-tape storage medium

(75) Inventors: Yung Yip, Afton, MN (US); Alan R. Olson, Cottage Grove, MN (US)

Correspondence Address: Attention: Eric D. Levinson, Imation Corp., Legal Affairs, P.O. Box 64898, St. Paul, MN, 55164-0898, US

(73) Assignee: Imation Corp.

(21) Appl. No.: 10/047,280

(22) Filed: Jan. 14, 2002

(51) Int. Cl. G06F 13/12

(52) U.S. Cl. 710/72

(57) ABSTRACT

A system is described including a data cartridge carrying a non-tape storage medium. The data cartridge includes read/write circuitry to access the non-tape storage medium and an external electrical connector coupled to the controller. The system further includes a tape drive emulator having an electrical socket to receive the electrical connector of the data cartridge. The socket may comprise a zero insertion force (ZIF) socket having a set of connectors that engage the electrical connections of the data cartridge. The tape drive emulator may mechanically actuate the ZIF socket upon sensing the insertion of the electrical interface of the data cartridge. Alternatively, the socket may include a mechanical actuation mechanism operable by a data cartridge library automation system to electrically couple the data cartridge to the emulation tape drive.

### TECHNICAL FIELD

The invention relates to data storage devices.

### BACKGROUND

Automated cartridge libraries provide access to vast amounts of electronic data by managing magnetic tape data cartridges. Automated cartridge libraries exist in all sizes, ranging from small library systems that may provide access to twenty or fewer data cartridges, to larger library systems that may provide access to thousands of data cartridges.

In a conventional automated cartridge library system, an automation unit, such as a robotic arm or other mechanism, typically services a plurality of data cartridge storage locations. The automation unit selectively retrieves a data cartridge from one of the storage locations and loads the retrieved data cartridges into a designated tape drive to access data stored by the data cartridge. Each data cartridge typically has some kind of identifying information, such as a label, a bar code, or a radio frequency (RF) tag, by which the automation unit identifies the individual tape cartridges.

When the tape drive is finished with the data cartridge, the automation unit retrieves the data cartridge from the tape drive and returns it to the assigned data cartridge storage location. A host computing system communicating with a library control unit that typically controls the operation of the automated cartridge library. In this way, a large number of data cartridges are automatically accessible by one or more tape drives.

To manipulate a data cartridge, the automation unit typically has an interface that engages the data cartridge and allows the automation unit to convey and manipulate the orientation of the tape cartridge. As a robotic arm, for example, the automation unit may include a gripper that grasps the selected data cartridge. Because the data cartridges must be positioned in a precise manner for the robotic arm to grasp them correctly, the data cartridges and the storage locations are constructed with exact dimensions. Accordingly, the data cartridges of the library system typically have substantially similar, if not identical, form factors to be received by the interface of the automation unit.

### SUMMARY

In general, the invention is directed to a system comprising a data cartridge carrying a non-tape storage medium. The data cartridge includes a controller to control access to the non-tape storage medium and an external electrical connector coupled to the controller. The system includes a tape drive emulator having an electrical socket to receive the electrical connector of the data cartridge. The socket may comprise a zero insertion force (ZIF) socket having a set of connectors that engage the electrical connections of the data cartridge. The tape drive emulator may mechanically actuate the ZIF socket upon sensing the insertion of the electrical interface of the data cartridge. Alternatively, the socket may include a mechanical actuation mechanism operable by a data cartridge library automation system to electrically couple the data cartridge to the emulation tape drive.

In another embodiment, the invention is directed to a data cartridge comprising a housing conforming to industry standard dimensions for a magnetic tape data cartridge. The data cartridge further comprises a non-tape storage medium and read/write circuitry for accessing the non-tape storage medium, and an externally available electrical connector coupled to the read/write circuitry. The data cartridge may further comprise a controller to control access to the non-tape storage medium. For example, the non-tape storage medium may comprise a disk-shaped storage medium and the controller may comprise a disk drive controller. The data cartridge may include a self-contained disk drive housing the disk-shaped storage medium and the disk drive controller.

In another embodiment, the invention is directed to a tape drive emulator. The tape drive emulator comprises an electrical socket to receive an electrical connector of a data cartridge carrying a non-tape storage medium. The socket may comprise a zero insertion force (ZIF) socket having a set of connectors that engage the electrical connections of the data cartridge. The tape drive emulator may also comprise a sensor to sense the insertion of the data cartridge. The tape drive emulator may mechanically actuate the ZIF socket upon sensing the insertion of the electrical interface of the data cartridge. Alternatively, the socket may include a mechanical actuation mechanism operable by a data cartridge library automation system to electrically couple the data cartridge to the emulation tape drive.

The tape drive emulator may comprise a host interface to electrically couple the tape drive emulator to a host computing device, and a translation unit to translate commands between the host interface and the data cartridge interface.

The invention may be capable of providing a number of advantages. By making use of the invention, an automated data cartridge system may include a number of conventional data cartridges housing magnetic tape, as well as a number of data cartridges housing non-tape media. Regardless of the type of internal storage media, the data cartridges have housings conforming to standard dimensions and features to be easily manipulated by the automation system. In this manner, the mechanical interfaces between the automation systems need not be adapted or upgraded to support data cartridges having non-tape media. In other words, because the data cartridges conform to standard dimensions, data cartridges housing different types of media can be mechanically indistinguishable by the automation system. Accordingly, the automated data cartridge system may readily include tape drives for accessing conventional magnetic tape data cartridges, and tape drive emulators for accessing data cartridges having non-tape media.

Furthermore, the data cartridges housing non-tape storage media may be self-contained storage devices that include necessary electronics and control circuitry for accessing the storage media. For example, a data cartridge may have standard external dimensions and features of a tape data cartridge, but may house a disk drive including the disk-shaped storage medium as well as the disk drive controller and read/write circuitry.

In addition, the tape drive emulator receives a data cartridge carrying the non-tape storage medium and translates commands and performs other operations such that the data cartridge appears as a conventional sequential storage device to the host computing device. In this manner, the non-tape storage medium physically appears the same as a magnetic tape data cartridge from the perspective of the automation system, and functionally appears the same from the perspective of the host computing device.

The external electrical connector of the data cartridge and the socket of the tape drive provide a robust electrical connection between the tape drive emulator and the data cartridge. The use of a Zero Insertion Force (ZIF) socket may allow the automation unit to easily insert and remove the data cartridge from the tape drive emulator. Accordingly, a wide variety of storage media may be used within a library automation system with little or no change to the automation unit or the host computing device.

The details of one or more embodiments of the invention are set forth in the accompanying drawings and the description below. Other features, objects, and advantages of the invention will be apparent from the description and drawings, and from the claims.

### BRIEF DESCRIPTION OF DRAWINGS

FIG. 1 is a block diagram illustrating an automated data cartridge library system.

FIG. 2 is a perspective view of a data cartridge having a non-tape storage medium and selected for insertion into a tape drive emulator.

FIG. 3 is a block diagram illustrating example embodiments of the tape drive emulator and the data cartridge having a non-tape storage medium.

FIG. 4 is a block diagram illustrating another example embodiment of a tape drive emulator and a data cartridge carrying a non-tape storage medium.

FIG. 5 is a block diagram illustrating another example embodiment of a data cartridge carrying a non-tape storage medium.

### DETAILED DESCRIPTION

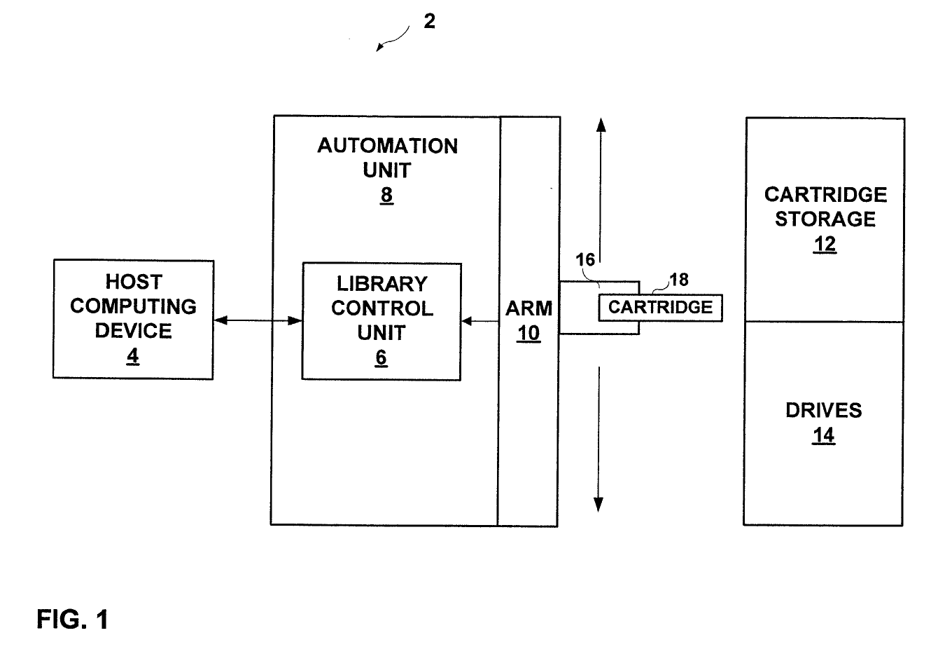

FIG. 1 is a block diagram illustrating an automated data cartridge library system 2. Automation unit 8 selectively retrieves a data cartridge 18 and loads the retrieved data cartridge 18 into one of drives 14. When the drive is finished with the data cartridge 18, automation unit 8 retrieves the data cartridge 18 from the drive and returns it to the assigned storage location within cartridge storage 12.

Accordingly, cartridge storage 12 provides a plurality of data cartridge storage locations. Each location, also referred to as a cell, provides storage for a single data cartridge. Each data cartridge typically includes a housing having standard dimensions and features to be easily engaged by automation unit 8. In addition, the data cartridges may have some type of identifying information, such as a label, a bar code, or a radio frequency (RF) tag, by which the automation unit 8 identifies the individual data cartridges.

A host computer 4 communicates with library control unit 6 to direct operation of data cartridge library system 2. In response to an access request from host computing device 4, library control unit 6 generates control signals to direct a robot arm 10 to retrieve the appropriate data cartridge from cartridge storage 12 and insert the data cartridge into one of drives 14. In particular, library control unit 6 interprets storage access requests from host computing device 4, and provides signals to control the motion and operation of robotic arm 10 and a gripper 16. In response to the signals, robotic arm 16 traverses cartridge storage 12 and engages a cartridge 18 using gripper 16. Upon insertion of data cartridge 18 into one of drives 14, host computing device 4 can write data to, and read data from, the data cartridge.

As described in detail herein, cartridge storage 12 may include a number of conventional data cartridges housing magnetic tape, as well as a number of data cartridges housing non-tape storage media. The non-tape storage media take the form of a variety of storage media, such as disk-shaped magnetic storage media, solid-state storage media, optical storage media, magneto-optical storage media, and holographic storage media.

Regardless of the type of internal storage media, the data cartridges have housings conforming to standard dimensions and features to be easily engaged by automation unit 8. Because the data cartridges conform to standard dimensions, cartridges housing different types of media are mechanically indistinguishable by automation unit 8. In this manner, the mechanical interfaces between automation unit 8 need not be adapted or upgraded to support non-tape media.

Furthermore, the data cartridges housing non-tape storage media may be self-contained storage devices that include necessary electronics and control circuitry for accessing the storage media. For example, a data cartridge may have standard external dimensions and features of a tape data cartridge, but may house a disk drive including the disk-shaped storage medium as well as the disk drive controller and read/write circuitry.

Accordingly, drives 14 may include one or more conventional tape drives and one or more tape drive emulators for receiving data cartridges housing non-tape storage media. In other words, drives 14 may include one or more tape drive emulators such that the non-tape storage media appear to host computing device 4 as sequential storage devices. Specifically, the tape drive emulators communicate with host computing device 4 as conventional tape drives. For example, in response to a query from host computing device 4, the tape drive emulators may identify themselves as conventional tape drives, such as a standard 3480 tape drive. Consequently, the drivers and other software applications executing on host computing device 4 for accessing tape-based data cartridges need not be modified.

As with the data cartridges carrying non-tape media, the tape drive emulators may be physically configured for use with conventional backup infrastructure, such as library system 2. For example, the tape drive emulators may conform to standard dimensions and form factors of conventional tape drives that may readily be inserted within a drive bay of library system 2. The tape drive emulators may, for example, have appropriately located power connectors, 25 mounting holes and electrical sockets for receiving data cartridges carrying non-tape media.

In this manner, data cartridges housing non-tape storage media physically appear the same as magnetic tape data cartridges from the perspective of automation unit 10, and functionally appears the same from the perspective of host computing device 4. Accordingly, a wide variety of storage media may be used within library automation system 2 with little or no change to automation unit 10 or host computing device 4. Although described in reference to library system 2, the principles of the invention are not limited to automated data cartridge systems. A system administrator or other user may, for example, manually insert the data cartridges into drives 14.

In addition, library system 2 can easily be migrated to larger storage capacities without upgrading drives 14. Unlike conventional systems in which the drives must be upgraded to support larger capacity magnetic tape data cartridges, the tape drive emulators can readily support non-tape data cartridges having increased storage capacities. For example, the tape drive emulators may readily detect the storage capacity of inserted data cartridges having non-tape storage media, possibly by querying the data cartridges, and report the storage capacity to host computing device 4. In this manner, library system 2 can be viewed as forward compatible with ensuing data cartridges having increased storage capacity.

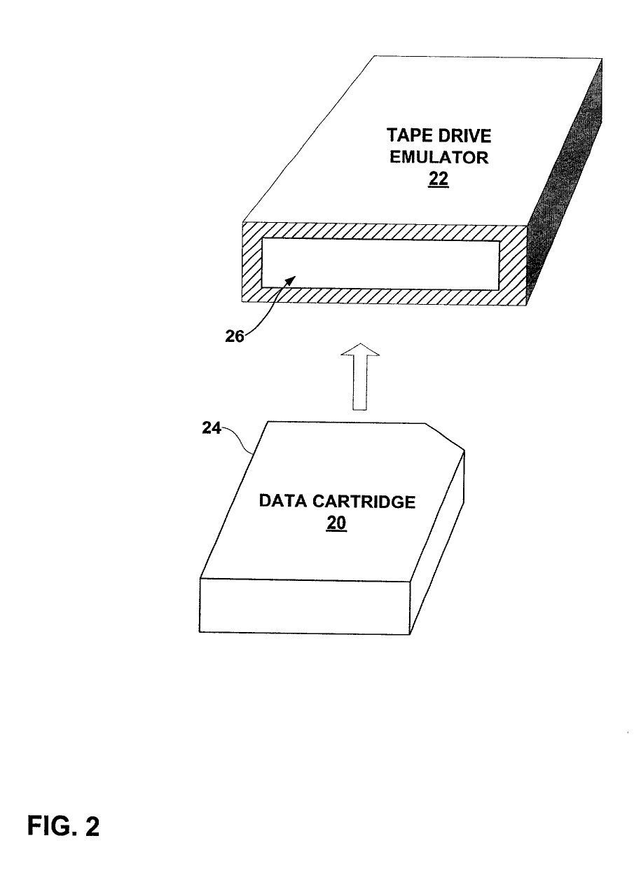

FIG. 2 is a perspective view of a data cartridge 20 selected from cartridge storage 12 (FIG. 1) for insertion into tape drive emulator 22 of drives 14. Data cartridge 20 contains a non-tape storage medium, and includes a housing 24 that conforms to standard external dimensions and features of magnetic tape data cartridges that may be used via system 2. For example, the external dimensions of data cartridge 20 may conform to one of a number of industry-standard form factors, such as the form factors of the Black Watch™ 9840 and Royal Guard™ 3480, 3490E, 3490EL and 9490EE magnetic storage tape cartridges manufactured by Imation Corp. of Oakdale, Minn.

Tape drive emulator 22 includes a socket 26 for receiving data cartridge 20. As illustrated below, unlike data cartridges used by system 2, socket 26 provides an electrical interface for accessing the non-tape storage medium contained with data cartridge 20. In particular, data cartridge 20 may house a fully self-contained non-tape storage device, including all necessary electronics and control circuitry for accessing the non-tape storage medium. For example, a data cartridge may house a disk drive including a disk-shaped storage medium as well as a disk drive controller, actuator, magnetic transducer, pre-amplifiers and read/write circuitry. Tape drive emulator 22 may have a form factor of a standard tape drive such that the location of socket 26 conforms to the location of a slot within the standard tape drive. In this manner, library system 2 may readily insert and remove data cartridge 20 without modification.

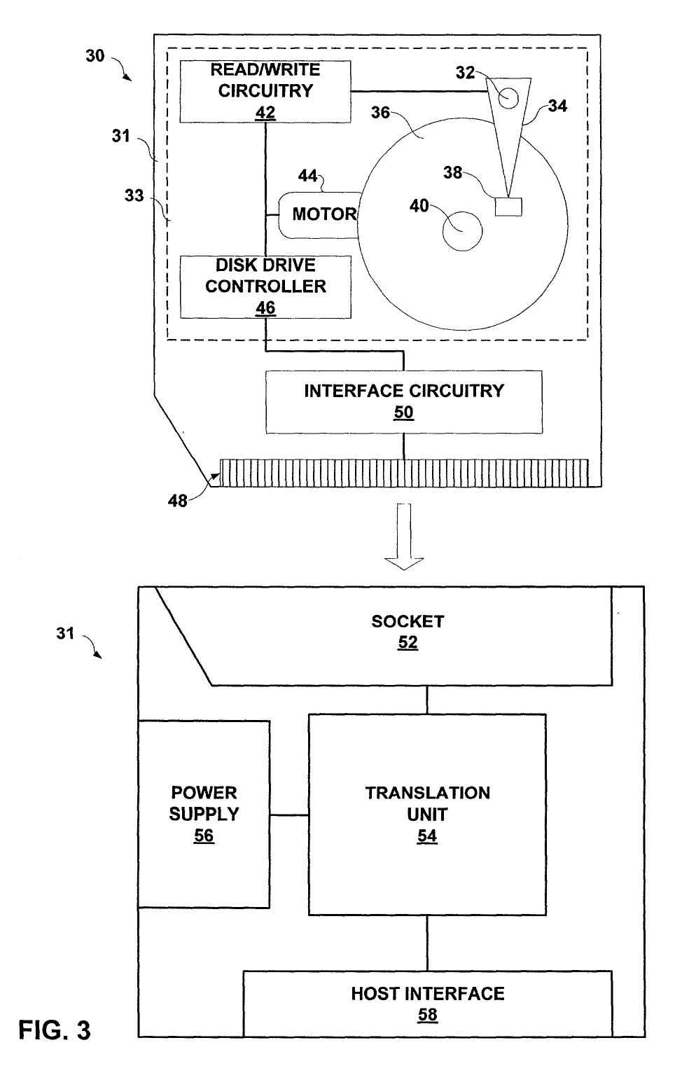

FIG. 3 is a block diagram illustrating example embodiments of a tape drive emulator 31 and a data cartridge 30 having a non-tape storage medium. Specifically, cartridge 30 includes a housing 31 that forms an enclosure for disk storage medium 36 and various other components. Disk storage medium 36 may be any disk-shaped storage medium such as magnetic, optic, magneto-optic and the like. In addition, disk storage medium 36 may be a hard disk or flexible disk. Spindle motor 44 rotates magnetic storage medium 36 around spindle hub 40. Actuator 34 rotates around actuator shaft 32, causing transducer 38 to traverse the rotating magnetic storage medium 36 for reading and writing data.

Disk drive controller 46 controls read/write circuitry 42 and actuator 34 to output signals to, and senses signals from, transducer 38. Disk drive controller 46 communicates with emulator 31 via interface 50. Interface 50 may implement a non-conventional communications protocol, or may implement any standard interface protocol, such as the Small Computer System Interface (SCSI), the Fiber Channel interface, the Enhanced Integrated Drive Electronics/AT Attachment (EIDE/ATA) interface, or the like. In this manner, data cartridge 30 may comprise a fully self-contained disk drive 33, as may be purchased as an off-the-shelf component from one of a number of disk drive manufactures, such as Seagate Technology of Scotts Valley, Calif.

Electrical connector 48 provides an externally available electrical interface for coupling to tape drive emulator 31 upon insertion by automation unit 10. In particular, electrical connector 48 provides input/output electrical pins for communicating with, and receiving power from, tape drive emulator 31.

Tape drive emulator 31 includes socket 52 to make a robust electrical connection to electrical connector 48 of data cartridge 30 upon insertion by automation unit 8. In one embodiment, socket 52 may comprise a zero insertion force (ZIF) socket. In particular, socket 52 may include a set of connectors operable to clamp and release electrical connector 48. Tape drive emulator 31 may, for example, mechanically actuate the connectors of socket 52 in response to sensing the insertion of the electrical connector of the data cartridge. Alternatively, gripper 16 may actuate a lever or other mechanical actuator of socket 52 to clamp down on and release the data cartridge 30. The layout of the mechanical connectors of socket 52 and the pins of connector 48 may take any one of a number of forms, such as array-shaped, staggered or in-line.

Host interface 58 provides an electrical interface between tape drive emulator 22 and host computing device 4. Host interface 58 may conform to any one of a number of standard communications interfaces such as the Small Computer System Interface (SCSI), the Fiber Channel interface, the Network Data Management Protocol (NDMP), the Enhanced Integrated Drive Electronics/AT Attachment (EIDE/ATA) interface, or the like.

Tape drive emulator 31 may include a translation unit 54 for translating commands received from host interface 58 prior to delivering the commands to data cartridge 30 via socket 52. For example, translation unit 54 may receive data stream commands from host interface 58 that are typical for sequential access devices, such as tape drives, and may translate the stream commands into block commands that are more typical for disk drives or other storage devices. In addition, translation unit 54 may provide data buffering, compression and decompression, data reformatting, error detection and correction, and the like, in order to provide a tape drive interface to host computer 4 and a non-tape interface to the data cartridge 30. In this manner, tape drive emulator 31 allows a data cartridge carrying a non-tape storage medium to appear to host computing device 4 as a sequential storage device.

Furthermore, translation unit 54 allows host interface 58 and electrical connector 48 of data cartridge 30 to conform to different interface specifications. For example, translation unit 54 may support a SCSI interface between tape drive emulator 31 and host computer device 4, and an EIDE interface between tape drive emulator 31 and data cartridge 30. Translation unit 54 may comprise one or more custom application-specific integrated circuits. Alternatively, translation unit 54 could be implemented as a single board computer.

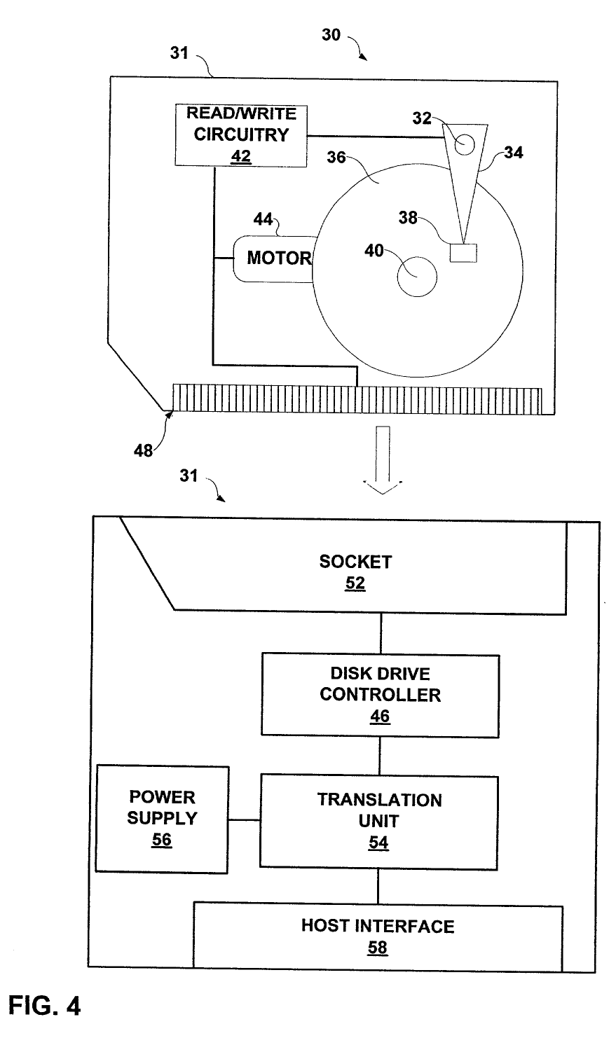

FIG. 4 is a block diagram illustrating another example embodiment of tape drive emulator 31 and data cartridge 30. In the illustrated embodiment, tape drive emulator 31 includes a portion of the drive electronics for accessing disk storage medium 36. Tape drive emulator 31 may include, for example, disk drive controller 46. As a result, data cartridge 30 may not need to include interface circuitry 50. In this manner, the cost and weight of data cartridge 31 may be reduced, which may be advantageous for high-volume applications. However, data cartridge 30 may no longer house a self-contained disk drive that can be purchased “off-the-shelf.” In either case, electrical connector and socket 52 provide a robust electrical connection between tape drive emulator 31 and data cartridge 30 upon insertion by automation unit 8.

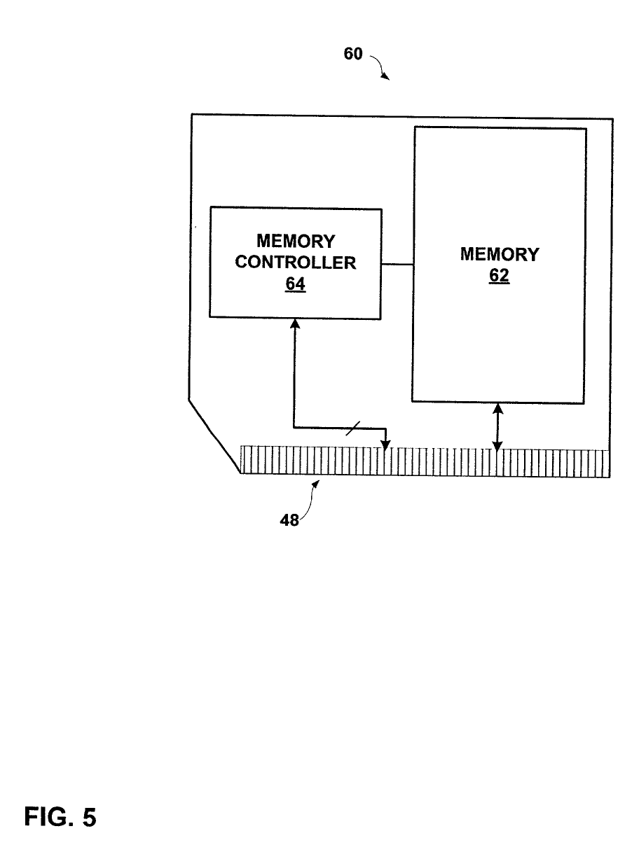

FIG. 5 is a block diagram illustrating another example embodiment of a data cartridge carrying a non-tape storage medium. Specifically, data cartridge 60 includes a solid-state memory 62 and a memory controller 64. Solid-state memory 62 may be any non-volatile memory such as an erasable programmable read only memory (EPROM), an electrically erasable programmable memory (FLASH memory), or the like. Memory controller 64 receives access requests from tape drive emulator 31 and performs address calculations to access storage locations within solid-state memory 62.

In this embodiment, translation unit 54 (FIG. 3) translates commands received from host interface 58 prior to delivering the commands to data cartridge 30 via socket 52. In particular, translation unit 54 translates the data stream commands from host interface 58 that are typical for tape drives into commands suitable for accessing one or more addressable storage cells within memory 62. In this manner, tape drive emulator 31 allows data cartridge 60 housing a solid-state storage medium to appear to host computing device 4 as a sequential storage device.

Various embodiments of the invention have been described. Nevertheless, it is understood that various modification can be made without departing from the spirit and scope of the invention. These and other embodiments are within the scope of the following claims.

1. A system comprising:
a data cartridge carrying a non-tape storage medium, wherein the data cartridge includes read/write circuitry to access the non-tape storage medium and an external electrical connector coupled to the read/write circuitry; and
a tape drive emulator having an electrical socket to receive the electrical connector of the data cartridge.

2. The system of claim 1, wherein the socket comprises a zero insertion force (ZIF) socket having a set of connectors that engage the electrical connections of the data cartridge.

3. The system of claim 2, wherein the tape drive emulator includes a sensor to sense the insertion of the data cartridge, wherein the tape drive emulator mechanically actuates the ZIF socket upon sensing the insertion of the electrical interface of the data cartridge.

4. The system of claim 2, wherein the socket includes a mechanical actuation mechanism operable by a data cartridge library automation system to electrically couple the data cartridge to the emulation tape drive.

5. The system of claim 1, wherein the tape drive emulator comprises a host interface to electrically couple the tape drive emulator to a host computing device.

6. The system of claim 5, wherein the host interface conforms to one of the Small Computer System Interface (SCSI), the Fiber Channel interface, the Network Data Management Protocol (NDMP), and the Enhanced Integrated Drive Electronics/AT Attachment (EIDE/ATA) interface.

7. The system of claim 5, wherein the tape drive emulator comprises a translation unit to translate commands between the host interface and the data cartridge interface.

8. The system of claim 7, wherein the translation unit receives data stream commands from the host interface and translates the data stream commands into data block commands.

9. The system of claim 8, wherein the translation unit comprises a data buffer for buffering the data stream commands.

10. The system of claim 1, wherein the non-tape storage medium comprises a disk-shaped storage medium.

11. The system of claim 10, wherein the data cartridge includes a self-contained disk drive housing the disk-shaped storage medium and a disk driver controller.

12. The system of claim 10, wherein data cartridge further comprises a disk drive controller to control access to the non-tape storage medium, wherein the controller communicates with the tape drive emulator according to one of the Small Computer System Interface (SCSI), the Fiber Channel interface, and the Enhanced Integrated Drive Electronics/AT Attachment (EIDE/ATA) interface.

13. The system of claim 1, wherein the socket of the tape drive emulator provides power to the controller of the data cartridge via the electrical connector of the data cartridge.

14. The system of claim 1, further comprising an automation unit to selectively retrieve the data cartridge from a plurality of data cartridges conforming to industry standard dimensions for magnetic tape data cartridges.

15. The system of claim 1, wherein the data cartridge comprises a housing conforming to industry standard dimensions for a magnetic tape drive cartridge.

16. The system of claim 1, wherein the tape drive emulator has a form factor of an industry standard tape drive such that the location of the socket conforms to the location of a slot within the industry standard tape drive.

17. The system of claim 16, wherein the tape drive emulator comprises a power connector and one or more mounting holes, and further wherein the dimensions of the tape drive emulator, the location of the power connector, and the location of the mounting holes conform to the industry standard tape drive.

18. The system of claim 1, wherein in response to a query from a host computing device the tape drive emulator identifies itself as an industry standard tape drive.

19. The system of claim 1, wherein the tape drive emulator determines the capacity of the non-tape storage medium within the data cartridge and communicates the capacity to a host computing device.

20. A data cartridge comprising:
a housing conforming to industry standard dimensions for a magnetic tape data cartridge;
a non-tape storage medium and read/write circuitry for accessing the non-tape storage medium, wherein the non-tape storage medium and the read/write circuitry are contained within the housing; and
an externally available electrical connector coupled to the read/write circuitry.

21. The data cartridge of claim 20, further comprising a controller to control access to the non-tape storage medium.

22. The data cartridge of claim 20, wherein the non-tape storage medium comprises a disk-shaped storage medium and the controller comprises a disk drive controller.

23. The data cartridge of claim 22, wherein the data cartridge includes a self-contained disk drive housing the disk-shaped storage medium and the disk driver controller.

24. The data cartridge of claim 20, wherein the controller receives power via the electrical connector.

25. The data cartridge of claim 20, wherein the non-tape storage medium comprises one of a solid-state storage medium, an optical storage medium, a magneto-optical storage medium, and a holographic storage medium.

26. A tape drive emulator comprising an electrical socket to receive an electrical connector of a data cartridge carrying a non-tape storage medium.

27. The tape drive emulator of claim 26, wherein the socket comprises a zero insertion force (ZIF) socket having a set of connectors that engage the electrical connections of the data cartridge.

28. The tape drive emulator of claim 27, further comprising a sensor to sense the insertion of the data cartridge, wherein the tape drive emulator mechanically actuates the ZIF socket upon sensing the insertion of the electrical interface of the data cartridge.

29. The tape drive emulator of claim 27, wherein the socket includes a mechanical actuation mechanism operable by a data cartridge library automation system to electrically couple the data cartridge to the emulation tape drive.

30. The tape drive emulator of claim 26, wherein the tape drive emulator comprises a host interface to electrically couple the tape drive emulator to a host computing device.

31. The tape drive emulator of claim 30, wherein the tape drive emulator comprises a translation unit to translate commands between the host interface and the data cartridge interface.

32. The tape drive emulator of claim 26, further comprising a controller to control access to the non-tape storage medium of the data cartridge.

33. The tape drive emulator of claim 26, wherein the non-tape storage medium comprises a disk-shaped storage medium and the controller within the tape drive emulator comprises a disk drive controller.

34. The tape drive emulator of claim 26, wherein the tape drive emulator has a form factor of an industry standard tape drive such that the location of the socket conforms to the location of a slot within the industry standard tape drive.

35. The tape drive emulator of claim 34, wherein the tape drive emulator comprises a power connector and one or more mounting holes, and further wherein the dimensions of the tape drive emulator, the location of the power connector, and the location of the mounting holes conform to the industry standard tape drive.

36. The tape drive emulator of claim 26, wherein in response to a query from a host computing device the tape drive emulator identifies itself as an industry standard tape drive.

37. The tape drive emulator of claim 26, wherein the tape drive emulator determines the capacity of the non-tape storage medium within the data cartridge and communicates the capacity to a host computing device.
